(19) United States
(12) Patent Application Publication
(10) Pub. No.: US 2019/0029075 A1
(43) Pub. Date: Jan. 24, 2019

(54) MESSAGE EXCHANGE METHOD, DEVICE, AND SYSTEM

(71) Applicant: HUAWEI TECHNOLOGIES CO., LTD., Shenzhen (CN)

(72) Inventors: Yuan WANG, Shanghai (CN); Jingwang MA, Shanghai (CN); Fenqin ZHU, Shanghai (CN)

(21) Appl. No.: 16/137,773

(22) Filed: Sep. 21, 2018

Related U.S. Application Data
(63) Continuation of application No. PCT/CN2016/076927, filed on Mar. 21, 2016.

(51) Int. Cl. H04W 88/18; H04W 48/18; H04W 48/00; H04W 76/11; H04L 29/06

(52) U.S. Cl. CPC H04W 88/184; H04W 48/18; H04L 63/0876; H04W 76/11; H04W 48/17

(57) ABSTRACT

The present invention relates to the communications field, and in particular, to a message exchange method, a device, and a system. The method may include: receiving, by a core network device, a message, where the message carries a message identifier; obtaining, by the core network device, a service rule set, where a service rule in the service rule set includes the message identifier and a corresponding network function module identifier; determining, by the core network device, a corresponding target network function module identifier in the service rule set; and sending the message to a network function module of the corresponding target network function module identifier. The service rule in the service rule set may be changed.

### CROSS-REFERENCE TO RELATED APPLICATIONS

This application is a continuation of International Application No. PCT/CN2016/076927, filed on Mar. 21, 2016, the disclosure of which is hereby incorporated by reference in its entirety.

### TECHNICAL FIELD

The present invention relates to the communications field, and in particular, to a message exchange method, a device, and a system.

### BACKGROUND

With rapid development of mobile communications technologies, a network architecture becomes increasingly complex, evolving many different network types, for example, an evolved packet core (Evolved Packet Core, EPC) network, and an architecture manner of a network element (Network Element, NE) is used in the EPC. A typical network element included in the architecture is, for example, a mobility management entity (Mobility Management Entity, MME), a serving gateway (Serving Gateway, S-GW), or a packet data network gateway (Packet Data Network Gateway, P-GW). A network function of the current EPC is implemented through a service feature and processing logic that are fixed in the network element and a procedure message between network elements. For example, mobility management, bearer management, and location management are implemented. For example, an access service of a user needs to be implemented by collaboration of the MME, the S-GW, the P-GW, and another network element such as a policy and charging rules function (Policy and Charging Rules Function, PCRF) unit, and a home subscriber server (Home Subscriber Server, HSS) in a network, and by using service procedure logic of a standardized definition. Therefore, a feature of the network function that can be provided by the current EPC is fixed.

However, with continuous expansion of a business model and continuous development of technologies, a service requirement of the user changes accordingly. The user service requires more service modes and better service features, such as a requirement for ultra-low latency communication, and a requirement for high-reliability communication. Therefore, a requirement for a new network function is brought. The network function provided by the EPC network is fixed and distributed in various network elements. Therefore, if the new network function needs to be introduced to support the user requirement, the EPC network needs to redefine and redesign the processing logic and procedure interaction of the network element. Such redesign means a long development cycle and high costs for an equipment vendor, and for a network operator, means that the new network function cannot be published in a timely manner and a new service cannot be provided to the user. In the conventional EPC network, the HSS presets a usage type for UE based on a type and a capability of the UE, and the network sets a corresponding core network based on each usage type. A specific forwarding process is as follows: After receiving a request from the UE, the network sends the request to a default MME in the network, then the default MME obtains a core network corresponding to the UE from the HSS, and finally a forwarding unit in the EPC network redirects the request to an MME of the corresponding core network, so as to complete network selection.

Therefore, a network element architecture of the conventional EPC can complete a network selection process only under support of the HSS. Because the corresponding core network is configured based on the usage type, a request event triggered by a timer in a functional network cannot be processed by invoking a service in the network, but needs to be implemented in another manner in the network. In addition, when a new function service is deployed in the network or an existing service is updated, both the UE and the HSS need to change the usage type to select a new network, resulting in poor scalability.

### SUMMARY

Embodiments of the present invention provide a message exchange method, a device, and a system, so as to implement message exchange between a network function module and another network entity when a network function is dynamically adjusted.

In view of this, a first aspect of the embodiments of the present invention provides a message exchange method, including:

first receiving, by a core network device, a message, where the message may carry a message identifier; then obtaining, by the core network device, a service rule set, where a service rule in the service rule set includes the message identifier and a network function module identifier corresponding to the message identifier; after determining the service rule set, determining, by the core network device, a target network function module identifier corresponding to the message identifier in the service rule set; and finally sending the message to a network function module corresponding to the target network function module identifier.

It can be learned that the core network device first receives the message having the message identifier and then obtains the service rule set. The service rule set has a correspondence between the message identifier and the network function module identifier. Therefore, the core network device determines the network function module identifier corresponding to the message identifier in the service rule set, then finds the corresponding network function by using the network function module identifier, and sends the message to the network function. In an entire network function selection period, HSS involvement is not required, and the message may be quickly located only by using the pre-stored correspondence in the service rule set. There is no special requirement for the message, and the message may be an internal message, or may be an external message. Provided that the message carries the message identifier, the corresponding network function may be properly selected.

In some embodiments, the message is a message sent by a device inside a service system in which the core network device is located, or a message sent by a device outside the service system. It may be understood that, in terms of generation means, the message may be actually classified into two types: the message sent by the device inside the service system, and the external message or a request message sent by the device outside the service system. Both types of messages can trigger a process of selecting the network function.

In some embodiments, the message identifier includes at least one of a timer timeout identifier, a message type identifier, and a function type identifier. It may be understood that, the message identifier may vary according to different messages, and can correspond to a message reflecting a corresponding type.

In some embodiments, the obtaining, by the core network device, a service rule set includes: obtaining, by the core network device, the service rule set from a storage device; or locally reading, by the core network device, the service rule set from the core network device. Actually, the core network device obtains the service rule set in a plurality of manners, for example, may obtain the service rule set from the storage device, and the service rule set may be preset and stored in the storage device. For another example, the core network device may locally read the service rule set from the core network device. To be specific, the configured service rule set is locally stored in the core network device, for example, in a storage medium of the core network device. When obtaining the service rule set, the core network device can directly read the service rule set from the storage medium.

In some embodiments, the external message may usually be the request message, and the request message may carry the message type identifier.

In some embodiments, a non-access stratum NAS message header of the request message includes the message type identifier, and the method further includes: determining, by the core network device, the message type identifier based on the NAS message header of the request message. The request message carries the message type identifier. Specifically, the message type identifier may be carried in the NAS message header of the request message, and determining of the message type identifier may be extraction of the message type identifier from the NAS message header of the request message.

In some embodiments, the message includes a trigger message and/or the request message, the trigger message carries the timer timeout identifier, and the request message carries the message type identifier. The internal message may be classified into the trigger message and the request message based on different types, and the two messages respectively carry different identifiers. The request message carries the message type identifier, and the trigger message carries the timer timeout identifier.

In some embodiments, the message identifier may include three cases. Therefore, the determining, by the core network device, a target network function module identifier corresponding to the message identifier in the service rule set includes: determining, by the core network device, the corresponding target network function module identifier in the service rule set based on the at least one of the timer timeout identifier, the message type identifier, and the function type identifier that are carried in the message.

In some embodiments, the message is the trigger message, and the determining, by the core network device, a target network function module identifier corresponding to the message identifier in the service rule set includes: determining, by the core network device, the corresponding target network function module identifier in the service rule set based on the timer timeout identifier carried in the trigger message. When the message is a type of the trigger message, because the trigger message carries the timer timeout identifier, the corresponding target network function module identifier can be determined based on the timer timeout identifier, so as to enhance realizability of the method in the present invention.

In some embodiments, the message is the request message, and the determining, by the core network device, a target network function module identifier corresponding to the message identifier in the service rule set includes: determining, by the core network device, the corresponding target network function module identifier in the service rule set based on the message type identifier carried in the request message. For the request message and the trigger message, because the two messages carry the message type identifier, the target network function module identifier may be determined in the service rule set by using the message type identifier.

In some embodiments, the service rule in the service rule set further includes a network slice identifier, and the network slice identifier in the service rule and the message identifier correspond to the network function module identifier. The method further includes: determining, by the core network device, a network slice identifier of the message based on the message. In this case, the determining, by the core network device, the target network function module identifier corresponding to the message identifier in the service rule set includes: determining, by the core network device, the network function module identifier in the service rule set based on the message identifier and the network slice identifier of the message. It can be learned that in some cases, for example, in an application scenario of a network slice, a plurality of network slices may have a same message identifier. In this case, the corresponding network function module identifier cannot be found by using the message identifier only. After the message identifier needs to be associated with the network slice identifier to determine the network slice, the corresponding network function module identifier is determined by using the message identifier in the service rule set corresponding to the network slice.

In some embodiments, the message further carries a UE identifier, the service rule in the service rule set further includes the network slice identifier, and the network slice identifier corresponds to the network slice. The determining, by the core network device, a target network function module identifier corresponding to the message identifier in the service rule set includes: determining, by the core network device, the network slice identifier based on the UE identifier; determining, by the core network device, a service rule group based on the network slice identifier, where the service rule group includes service rules having a same network slice identifier; and determining, by the core network device, the target network function module identifier corresponding to the message identifier in the service rule group based on the message identifier of the message. It can be learned that when applied to a network slicing service, the message further carries the UE identifier, the UE identifier uniquely corresponds to one network slice, to be specific, a network function required by UE is provided by the network slice, each network slice corresponds to one network slice identifier, and the network slice identifier is included in each service rule in the service rule set. Therefore, the entire service rule set may be divided into several service rule groups, and each service rule group is responsible for serving one network slice.

In some embodiments, the message further carries the UE identifier, each network slice corresponds to one service rule set, the service rule set further includes the network slice identifier, and the network slice identifier corresponds to the network slice. The determining, by the core network device, a target network function module identifier corresponding to the message identifier in the service rule set includes: determining, by the core network device, the network slice identifier based on the UE identifier; determining, by the core network device, a target service rule set based on the network slice identifier; and determining, by the core network device, the target network function module identifier corresponding to the message identifier in the target service rule set based on the message identifier of the message. It can be learned that when applied to the network slicing service, the message further carries the UE identifier, the UE identifier uniquely corresponds to one network slice, to be specific, the network function required by the UE is provided by the network slice, each network slice corresponds to one network slice identifier, and the network slice identifier is included in each service rule in the service rule set. Therefore, a plurality of service rule sets may be set, each service rule set is responsible for serving one network slice, and the network slice identifier is set in each service rule set.

In some embodiments, the determining, by the core network device, a network slice identifier of the message based on the message includes: determining, by the core network device, the network slice identifier of the message based on a UE identifier when the message carries the UE identifier; or obtaining, by the core network device, the network slice identifier carried in the message. It can be learned that there are two manners of determining the network slice identifier of the message by using the message. First, the message carries the UE identifier, and the UE identifier can correspond to the network slice identifier. Second, the network slice identifier is directly carried in the message.

In some embodiments, there may be two manners of determining the network slice identifier. The determining, by the core network device, the network slice identifier of the message based on a UE identifier when the message carries the UE identifier includes: querying and determining, by the core network device, the network slice identifier of the message in a subscription data center based on the UE identifier, where a correspondence between the network slice identifier of the message and the UE identifier is stored in the subscription data center; or determining, by the core network device, the network slice identifier of the message by parsing the UE identifier, where the UE identifier carries the network slice identifier. Actually, there are a plurality of manners of obtaining the network slice identifier by the core network device based on the UE identifier. For example, when the UE identifier is available, the network slice identifier may be directly obtained from the subscription data center. For another example, the UE identifier carries the network slice identifier, and the network slice identifier may be obtained by parsing the UE identifier.

In some embodiments, before the determining, by the core network device, a target network function module identifier corresponding to the message identifier in the service rule set, the method further includes: determining, by the core network device, the corresponding UE identifier based on the timer timeout identifier in the trigger message, where a timer that generates the timer timeout identifier corresponds to the UE identifier. When the message is the trigger message, the UE identifier is usually not directly included in the trigger message, but in a context database of the UE. Because maintenance of the timer corresponds to the UE, the UE may be corresponded by using the timer timeout identifier, so as to determine the UE identifier in the context database of the UE.

A second aspect of the present invention further provides a core network device, including:

a receiving module, configured to receive a message, where the message carries a message identifier;

a processing module, configured to: obtain a service rule set, where a service rule in the service rule set includes the message identifier and a network function module identifier corresponding to the message identifier; and determine a target network function module identifier corresponding to the message identifier in the service rule set; and

a sending module, configured to send the message to a network function module corresponding to the target network function module identifier.

In some embodiments, the message is a request message sent by a device inside a service system in which the core network device is located, or an external message sent by a device outside the service system.

In some embodiments, the message identifier includes at least one of a timer timeout identifier, a message type identifier, and a function type identifier.

In some embodiments, the processing module is specifically configured to:

locally read the service rule set from the core network device; or

obtain the service rule set from a storage device.

In some embodiments, the request message carries the message type identifier.

In some embodiments, a non-access stratum NAS message header of the request message includes the message type identifier, and the processing module is further configured to:

determine the message type identifier based on the NAS message header of the request message.

In some embodiments, the message includes a trigger message and/or a request message, the trigger message carries the timer timeout identifier, and the request message carries the message type identifier.

In some embodiments, the processing module is specifically configured to:

determine the corresponding target network function module identifier in the service rule set based on the at least one of the timer timeout identifier, the message type identifier, and the function type identifier that are carried in the message.

In some embodiments, the service rule in the service rule set further includes a network slice identifier, the network slice identifier in the service rule and the message identifier correspond to the network function module identifier, and the processing module is further configured to determine a network slice identifier of the message based on the message.

That the processing module determines the network function module identifier corresponding to the message identifier in the service rule set includes:

determining, by the processing module, the network function module identifier in the service rule set based on the message identifier and the network slice identifier of the message.

In some embodiments, the message further carries a UE identifier, the service rule in the service rule set further includes the network slice identifier, and the network slice identifier corresponds to a network slice. The processing module is specifically configured to:

determine the network slice identifier based on the UE identifier;

determine a service rule group based on the network slice identifier, where the service rule group includes service rules having a same network slice identifier; and

determine, based on the message identifier of the message, the target network function module identifier corresponding to the message identifier in the service rule group.

In some embodiments, the message further carries the UE identifier, each network slice corresponds to one service rule set, the service rule set further includes the network slice identifier, and the network slice identifier corresponds to the network slice. The processing module is specifically configured to:

determine the network slice identifier based on the UE identifier;

determine the service rule group based on the network slice identifier, where the service rule group includes service rules having a same network slice identifier; and

determine, based on the message identifier of the message, the target network function module identifier corresponding to the message identifier in the service rule group.

In some embodiments, when the message carries the UE identifier, the processing module is specifically configured to:

query and determine the network slice identifier of the message in a subscription data center based on the UE identifier, where a correspondence between the network slice identifier of the message and the UE identifier is stored in the subscription data center; or

determine the network slice identifier of the message by parsing the UE identifier, where the UE identifier carries the network slice identifier.

In some embodiments, the processing module is further configured to:

determine the corresponding UE identifier based on the timer timeout identifier in the trigger message, where a timer that generates the timer timeout identifier corresponds to the UE identifier.

A third aspect of the present invention further provides a network system, including:

a core network device, configured to: receive a message, where the message includes a message identifier; obtain a service rule set, where a service rule in the service rule set includes the message identifier and a network function module identifier corresponding to the message identifier; determine a target network function module identifier corresponding to the message identifier in the service rule set; and send the message to a network function module corresponding to the target network function module identifier; and

the network function module, configured to: receive the message sent by the core network device, and provide a network function service.

In some embodiments, the message identifier includes at least one of a timer timeout identifier, a message type identifier, and a function type identifier.

In some embodiments, the message is a message sent by a device inside a service system in which the core network device is located to the core network device, or a message sent by a device outside the service system to the core network device.

In some embodiments, the core network device is specifically configured to locally read the service rule set from the core network device; or

the system further includes a storage device, configured to store the service rule set, and the core network device is specifically configured to obtain the service rule set from the storage device.

In some embodiments, the service rule in the service rule set further includes a network slice identifier, the network slice identifier in the service rule and the message identifier correspond to the network function module identifier, and the core network device is further configured to determine a network slice identifier of the message based on the message.

The core network device is specifically configured to determine the network function module identifier in the service rule set based on the message identifier and the network slice identifier of the message.

In some embodiments, the core network device is specifically configured to:

determine the network slice identifier of the message based on a UE identifier when the message carries the UE identifier; or

obtain the network slice identifier carried in the message.

In some embodiments, when the message carries the UE identifier, the core network device is specifically configured to:

query and determine the network slice identifier of the message in a subscription data center based on the UE identifier, where a correspondence between the network slice identifier of the message and the UE identifier is stored in the subscription data center; or

determine the network slice identifier of the message by parsing the UE identifier, where the UE identifier carries the network slice identifier.

A fourth aspect of the present invention still further provides a network system, including:

a network function module, configured to: define a service rule and provide a network function corresponding to the service rule, where the service rule includes a message identifier and a network function module identifier corresponding to the message identifier;

a service management framework module, configured to register the service rule and a network function module corresponding to the service rule, and further configured to store a service rule set that includes the service rule in the network system; and

a process coordinator module, configured to:

receive a message, where the message includes a message identifier;

obtain the service rule set;

determine a target network function module identifier corresponding to the message identifier in the service rule set; and
send the message to a network function module corresponding to the target network function module identifier.

In some embodiments, the process coordinator module is further specifically configured to:

send the network function module identifier to the service management framework module; and

the service management framework module is further configured to:

receive the network function module identifier and determine, based on the network function module identifier, a network address of the network function module corresponding to the network function module identifier; and

send the network address to the process coordinator module.

In some embodiments, the process coordinator module is further configured to:

forward, based on the network address, the message to the network function module corresponding to the network address.

In some embodiments, the service management framework module is further configured to:

determine that the service rule of the registered network function module is changed; and

update, based on the changed service rule set, the service rule set stored in the network system.

In some embodiments, the process coordinator module is specifically configured to:

determine the target network function module identifier corresponding to a message type identifier and/or a timer timeout identifier in the service rule set.

In some embodiments, the network system further includes a subscription data center, configured to predefine and store a correspondence between a network slice identifier and a UE identifier, where the network slice identifier corresponds to a network slice; and

the process coordinator module is specifically configured to:

determine the network slice identifier based on the UE identifier, where the service rule in the service rule set further includes the network slice identifier;

determine a service rule group based on the network slice identifier, where the service rule group includes service rules having a same network slice identifier; and

determine, based on the message identifier, the target network function module identifier corresponding to the message identifier in the service rule group.

In some embodiments, the network system further includes a network function component module, and the network function component module is configured to be invoked by one or more network function modules, and includes at least one of the following modules: a user data management module, a security module, a bearer management module, and a policy management module.

In some embodiments, the service management framework module is further configured to add, delete, and update at least one of the network function modules.

It can be learned from the foregoing technical solutions that there are the following advantages in the embodiments of the present invention: the core network device obtains the service rule set, determines the target network function module identifier based on the message identifier carried in the received message and the service rule set, and sends the received message to the network function module corresponding to the target network function module identifier. The service rule in the service rule set may be changed. Therefore, when a new function service is deployed in a network or an existing service is updated (in other words, when the network function is dynamically adjusted), one or more service rules corresponding to the network function in the service rule set are adjusted, and then the method embodiment in the present invention is performed to implement a subsequent message exchange process, so as to improve execution efficiency of the network.

### BRIEF DESCRIPTION OF DRAWINGS

FIG. 1 is a schematic structural diagram of an existing EPC network;

FIG. 2 is a schematic diagram of a system architecture according to an embodiment of the present invention;

FIG. 3 is a diagram of an embodiment of a message exchange method according to an embodiment of the present invention;

FIG. 4 is a diagram of another embodiment of a message exchange method according to an embodiment of the present invention;

FIG. 5 is a diagram of another embodiment of a message exchange method according to an embodiment of the present invention;

FIG. 6 is a diagram of an embodiment of a core network device according to an embodiment of the present invention;

FIG. 7 is a diagram of an embodiment of a network system according to an embodiment of the present invention;

FIG. 8 is a diagram of an embodiment of a network system according to an embodiment of the present invention;

FIG. 9 is a diagram of an embodiment of a core network device according to an embodiment of the present invention; and

FIG. 10 is a diagram of an embodiment of a network system according to an embodiment of the present invention.

### DESCRIPTION OF EMBODIMENTS

Embodiments of the present invention provide a message exchange method, a device, and a system, which are used to change a service rule in a service rule set to implement a subsequent message exchange process when a new function service is deployed in a network or an existing service is updated, so as to improve execution efficiency of the network. To make persons skilled in the art understand the technical solutions in the present invention better, the following clearly describes the technical solutions in the embodiments of the present invention with reference to the accompanying drawings in the embodiments of the present invention. Apparently, the described embodiments are merely some but not all of the embodiments of the present invention.

Details are separately described in the following.

In the specification, claims, and accompanying drawings of the present invention, the terms “first”, “second”, “third”, “fourth”, and so on (if existent) are intended to distinguish between similar objects but do not necessarily indicate a specific order or sequence. It should be understood that the data termed in such a way is interchangeable in proper circumstances so that the embodiments of the present invention described herein can be implemented in other orders than the order illustrated or described herein. Moreover, the terms “include”, “contain” and any other variants mean to cover the non-exclusive inclusion, for example, a process, method, system, product, or device that includes a list of steps or modules is not necessarily limited to those expressly listed steps or modules, but may include other steps or modules not expressly listed or inherent to such a process, method, system, product, or device.

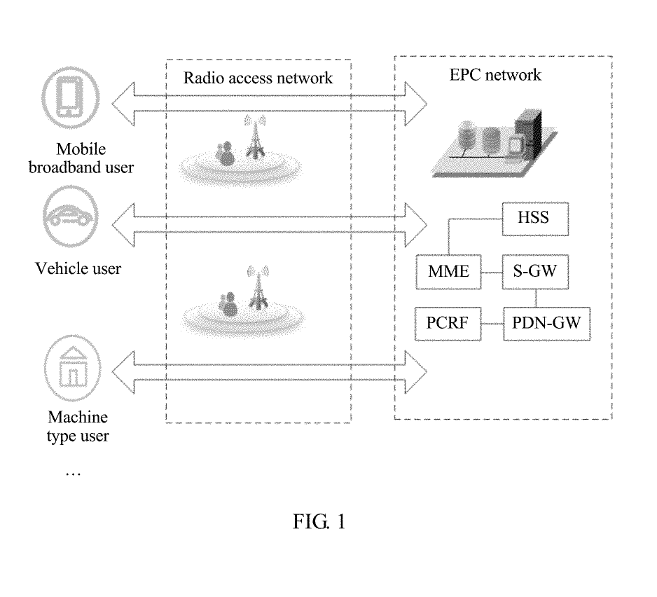

For ease of understanding, a specific example of an application scenario of an embodiment of the present invention is first provided. As shown in FIG. 1, FIG. 1 is a schematic structural diagram of an existing EPC network. User equipment (User Equipment, UE) in this EPC network architecture is a terminal that obtains a service in this communications system, and includes but is not limited to a mobile broadband (mobile broadband, MBB) type terminal, a machine type communication (Machine Type Communication, MTC) type terminal, a vehicle to vehicle (Vehicle to Vehicle, V2V) type terminal, and the like. The UE may be connected to a core network by using an access network, and the core network provides a corresponding service to the user equipment. A control plane of the core network provides a control plane service that includes registration access, location update, location switching, bearer setup, and the like of the UE. It should be understood that the core network herein may also be referred to as a non-access network, and the non-access network herein is a network that is different from the access network and provides at least one or more of the following function combinations. These functions may include: non-access stratum (Non-Access Stratum, NAS) signaling processing, NAS security, authentication (authentication), access control (access control), authorization (authorization), bearer management (bearer management) or session management (session management), mobility management, location management, lawful interception, roaming, and the like.

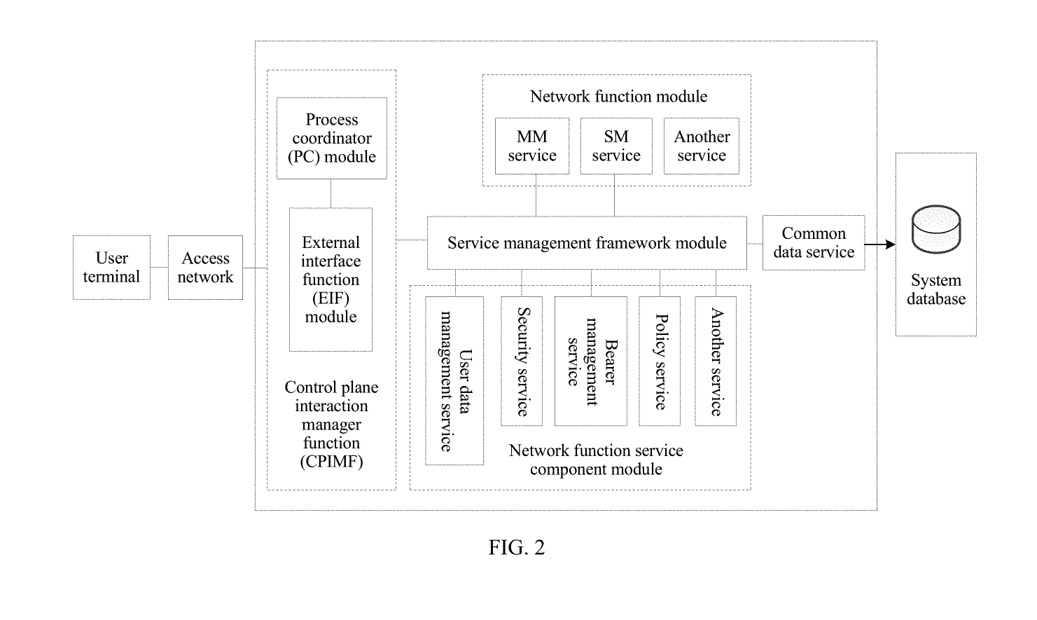

FIG. 2 is a schematic diagram of a system architecture according to an embodiment of the present invention. In the architecture shown in FIG. 2, a core network control plane function is implemented in a “network function plus service-oriented architecture” manner. Compared with a conventional core network architecture such as an EPC architecture, the architecture of the present invention does not include a conventional network element included in the EPC architecture, such as a mobility management entity (Mobility Management Entity, MME), a serving gateway (Serving Gateway, S-GW), and a packet data network gateway (Packet Data Network Gateway, P-GW), but connects network functions originally distributed in various network elements in series, to integrate and reconstruct a service-oriented control plane architecture that uses a network function as a basic unit. The network function is one or more relatively independent and complete logical functions, can process a similar type of service request from the UE or another entity in a network, and is responsible for performing a corresponding processing procedure, so as to complete a corresponding network function, for example, a registration access service of the UE and a location update service of the UE.

Specifically, the architecture shown in FIG. 2 mainly includes an external interface function (External Interface Function, EIF) module, a process coordinator (Process Coordinator, PC) module, a network function module, a network function component module, and a service management framework module. The following separately describes a function of each component. It should be understood that a name of the component herein is not unique. For ease of description, the following describes each component by using the foregoing name.

An EIF is an external interface function of an entire service-oriented control plane architecture, and exchange a message with another network element. The EIF is responsible of implementing an interface function between a function module (including a PC, the network function module, the network function component module, and the like) in the control plane architecture and an entity, including communication channel establishment, connection context maintenance, message protocol encapsulation and decapsulation, message forwarding and receiving, and the like.

The PC is a unified network function coordination module of the entire service-oriented control plane architecture. The PC is responsible for selecting, based on a message sent by the function module in a service-oriented control plane or a message sent by another network entity (such as the UE, a RAN node, a user plane entity, or a network entity of another network) outside the service-oriented control plane, a network function module that can process the foregoing message, and sends the foregoing message to the selected network function module. In this process, the PC may further be responsible for detecting and processing a service request conflict (for example, when a new service request conflicts with a current service procedure, preferential execution, suspension, or rejection of the service request is determined).

It should be noted that, depending on actual deployment, the EIF and the PC may be separately deployed or may be deployed in an integrated manner. In the case of integrated deployment, the device deployed in an integrated manner may perform functions of both the EIF and the PC. For example, the device deployed in an integrated manner may be a control plane interaction manager function (Control Plane Interaction Manager Function, CPIMF).

The network function module is a basic component unit of the network function implemented by the entire service-oriented control plane architecture, and may also be referred to as a network function unit. The network function module is a relatively independent and complete logical function entity. The network function module can receive a particular type or some types of messages, process a message, and complete a corresponding network function. For example, the network function module may complete the registration access service of the UE, the location update service of the UE, a switching service of the UE, and the like. In addition, the network function module may further be one or more network function component modules obtained based on a service execution sequence combination.

The network function component module is an abstract and independent universal network function unit in the entire service-oriented control plane architecture, and may also be referred to as a network function component unit. Usually, the network function component module may be invoked by one or more network function modules, to perform a specific universal network function required in the network function that is implemented by the network function module. For example, a security verification service and a bearer setup service may be completed by the network function component module, and may be invoked by the registration access service of the UE, the switching service of the UE, and the like. In addition, the network function component module may further be built in the network function module.

The service management framework module is a unit that performs a service management function in the entire service-oriented control plane architecture.

The network function unit in the network, such as the network function module and the network function component module, may store related information (such as a service rule set) of the network function unit in the service management framework module in a function registration manner. The another entity in the network may obtain the related information of the network function unit by using the service management framework module, so as to discover and invoke the network function unit.

In addition, it should be further noted that, the service-oriented control plane architecture is different from distributed and repeated storage of user data by the conventional network element. Instead, service processing logic of the network function is decoupled from to-be-processed user data, a user context, a security context, and a bearer context that are stored in the conventional network element, a network policy, and the like are stored in a unified database, and a common data service provides access to the database.

In addition, in the prior art, the EPC network proposes a dedicated core (Dedicated Core, DECOR) network technology to support different service requirements of a plurality of types of users, to be specific, to construct a regional dedicated network by using a function-customized network element set, and uses a dedicated core network selection technology to select a corresponding dedicated network for some user equipment that has a specific service requirement, so as to ensure that these users can access the dedicated network and select a corresponding network function. Specific steps of the network selection technology are as follows:

(1) UE sends a request message to a radio access network node.

(2) The radio access network node cannot learn a DECOR corresponding to the UE. Therefore, the radio access network node randomly selects one mobility management entity (Mobility Management Entity, MME) as a default MME when ensuring load balancing, and then sends the received request message of the UE to the default MME.

(3) The default MME processes the request message of the UE, obtains subscription information of the UE, and then determines, based on the subscription information of the UE, a DECOR MME corresponding to the UE. If the DECOR MME corresponding to the UE is inconsistent with the default MME, the default MME sends a redirection message to the radio access network node.

(4) After receiving the redirection message, the radio access network node sends the request message of the UE to the DECOR MME corresponding to the UE again.

It can be learned that in the foregoing method, when a network corresponding to the UE is selected, a redirection process is usually required. Therefore, there are the following problems when the network selection technology is applied to a 5G network architecture: because a network slice is usually a network that performs optimized configuration for a particular type of UE and provides a customized service and different network slices use different UE verification manners, a randomly selected network slice cannot obtain subscription data of the UE due to failure to perform authentication on the UE, and therefore cannot determine a real network slice corresponding to the UE, and cannot select a corresponding network function for the UE. In addition, the radio access network node may perform a redirection process when selecting the network slice for the UE. In the redirection process, the radio access network node needs to cache the request message of the UE, and needs to repeatedly send the request message. This significantly increases a burden of the radio access network node.

It should be understood that a network function selection method and an apparatus in the embodiments of the present invention are not limited to the network architectures shown in FIG. 1 and FIG. 2. The embodiments of the present invention may be further applied to another network architecture that is similar to network function modularization or servitization.

To resolve the foregoing problems, the embodiments of the present invention provide a message exchange method.

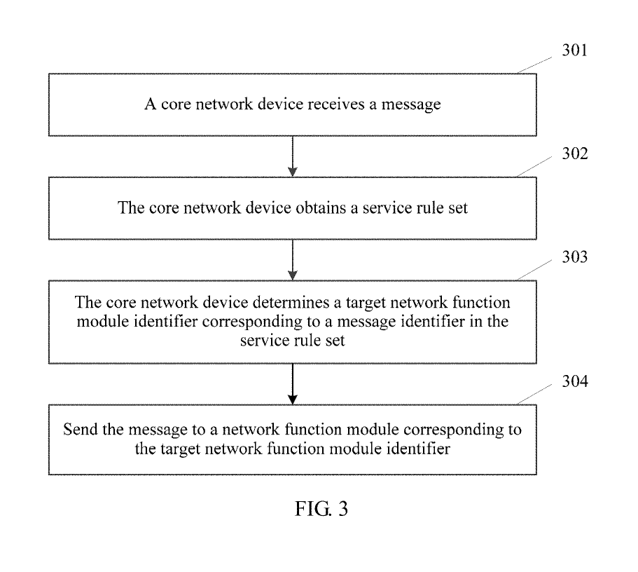

Referring to FIG. 3, FIG. 3 is a diagram of an embodiment of a message exchange method according to an embodiment of the present invention. As shown in FIG. 3, the method may include the following content.

301. A core network device receives a message.

The message includes a message sent by a device inside a service system in which the core network device is located, or a request message sent by a device outside the service system. Both the message inside the service system and the external message carry a message identifier.

It should be noted that the service system in this embodiment of the present invention is a control plane in a communications network, for example, may be the foregoing service-oriented control plane architecture.

A network system in this embodiment of the present invention is the communications network, and may include a service system.

It should be noted that the message identifier includes at least one of a timer timeout identifier, a message type identifier, and a function type identifier.

It should be noted that the core network device may be a PC or an EIF or a two-in-one deployed device having a CPIMF shown in FIG. 2, and the core network device has a network element selection function. When the core network device is the PC, a request message of UE may be forwarded to the EIF by using an access network element such as a radio base station, and then is forwarded by the EIF to the core network device after processing. However, if the core network device is the EIF, the core network device may directly obtain the request message of the UE through forwarding performed by the access network element such as the radio base station.

Optionally, there are two types of messages: one is the message sent by the device inside the service system in which the core network device is located, and the message may be further classified into a request message and a trigger message. The other is a message sent by the device outside the service system in which the core network device is located, and these messages may be classified into a request message and a trigger message. The request message and the trigger message are generated in different manners. The trigger message may be a message generated by triggering an internally or externally maintained timer of the service system in which the core network device is located, and the request message is a message that carries a request service and that is sent by these devices.

Optionally, there may be three types of message identifiers included in the message: the message type identifier, the timer timeout identifier, and the function type identifier. Specifically, the message type identifier may be a type identifier carried in a message header, to indicate a type of the message, for example, a message type field included in a message header of a non-access stratum NAS message. The timer timeout identifier may be an identifier that is carried in the trigger message sent after a timer expires, and may indicate that a specific type of timer of specific UE expires. The function type identifier may be a function type identifier carried in the message or the message header, to indicate that the message specifically requests a specific type of network function, for example, to indicate a mobility management function or a session management function requested by the message in a protocol descriptor (Protocol descriptor) field of the message.

The request message usually carries the message type identifier and/or the function type identifier, and the trigger message may carry the timer timeout identifier.

For example, an event timer may be maintained in a database inside or outside the service system in which the core network device is located. When the timer expires, a trigger message is sent. After receiving the trigger message, the core network device may determine the timer timeout identifier carried in the trigger message. For another example, when receiving an internal request message from the service system or an external request message, the core network device may determine a corresponding message type identifier and/or the function type identifier, so as to perform subsequent processing.

302. The core network device obtains a service rule set.

There is no sequence between step 302 and step 301.

A service rule in the service rule set includes the message identifier and a network function module identifier corresponding to the message identifier. To be specific, when the message identifier is the message type identifier, the message type identifier corresponds to the network function module identifier. When the message identifier is the timer timeout identifier, the timer timeout identifier corresponds to the network function module identifier. When the message identifier is the function type identifier, the function type identifier corresponds to the network function module identifier.

It should be noted that there may be a plurality of manners of obtaining the service rule set. Optionally, in a first manner, the core network device obtains the service rule set from another storage device. In a second manner, the core network device locally reads the service rule set from the core network device. For the first manner, after the service rule set is generated, a network function module may provide the service rule set to a service management framework module in a function registration manner, and the service management framework module uniformly stores and manages service rule sets generated by all network function modules. The core network device may obtain the required service rule set of the network function module from the service management framework module and locally store the service rule set.

Because the service rule set is a set that includes a preset service rule, the service rule set may be stored in the storage device after being generated. When starting to work, the core network device reads the service rule set from the storage device to the core network device. In another manner, the service rule set is directly locally stored in the core network device after being generated, for example, the service rule set is configured on the core network device as a configuration file. The network function module identifier corresponds to a network function used to serve the UE.

It may be understood that after determining the corresponding message identifier, the core network device may determine the network function module identifier based on the message identifier. The following describes the service rule by using Table 1-1.

TABLE 1-1

| Event ID | | | NF ID |
|---|---|---|---|
| Message Type ID | Timer Trigger ID | Function Type ID | |

In the table, Event ID indicates an event identifier, Message Type ID indicates the message type identifier, Timer Trigger ID indicates the timer timeout identifier, Function Type ID indicates the function type identifier, and NF ID indicates the network function module identifier. It can be seen that one service rule includes five items, one Event ID may be uniquely determined by using the Message Type ID, or the Timer Trigger ID, or the Function Type ID, and one NF ID may be determined by using one Event ID, so as to determine a corresponding network function module. The network function module identifier may be identification information corresponding to the network function, or may be an access address corresponding to the network function or other information that can uniquely identify the network function.

Optionally, in addition to the case shown in Table 1-1, the service rule may further be a service rule shown in the following Table 1-2.

TABLE 1-2

| | |
|---|---|
| Message Type ID | NF ID |
| Timer Trigger ID | |
| Function Type ID | |

The message identifier may be the message type identifier Message Type ID, or may be the timer timeout identifier Timer Trigger ID, or may be the function type identifier Function Type ID. To be specific, one NF ID may be uniquely determined by using the Message Type ID or the Timer Trigger ID or the Function ID, so as to determine the corresponding network function module.

Optionally, when only the message type identifier is available, a service rule shown in the following Table 1-3 may be further used.

TABLE 1-3

| | | | |
|---|---|---|---|
| NF_A ID | Message Type 1 | Message Type 2 | Message Type 3 |
| NF_B ID | Message Type 4 | Message Type 5 | Message Type 6 |

In the table, NF_A ID and NF_B ID are network function module identifiers, and Message Type indicates the message type identifier. It can be seen that a network function NF_A can process messages whose Message Types are 1, 2, and 3, and a network function NF_B can process messages whose Message Types are 4, 5, and 6. Therefore, the corresponding network function module identifier that can process the message may be determined based on the message type of the message.

The foregoing specific use of Table 1-1, Table 1-2, or Table 1-3 may be determined according to an actual situation, and this is not specifically limited.

Specific generation of Table 1-1, Table 1-2, and Table 1-3 may be defined by the network function module. The network function module may generate the foregoing service rule set based on a message that can be processed by the network function module. Specifically, the message that can be processed by the network function module includes the message sent by the device inside the service system in which the core network device is located and the message sent by the device outside the service system in which the core network device is located. The network function module generates a specific form of the foregoing service rule set based on the message identifier that can be processed by the network function module and the network function module identifier of the network function module.

Optionally, in an actual running process, the network function module may dynamically update the service rule set. Specifically, the network function module determines, based on an updated service, the message identifier that can be processed by the network function module, and generates the specific form of the foregoing service rule set again based on the determined message identifier and the network function module identifier of the network function module.

After the foregoing service rule set is generated, the network function module may provide the service rule set to the service management framework module in the function registration manner, and the service management framework module uniformly stores and manages the service rule sets generated by all the network function modules. The core network device may obtain the required service rule set of the network function module from the service management framework module and locally store the service rule set.

The following specifically describes the generation of the service rule with reference to Table 1-1. First, the message type identifier is described. After the network function module that serves a particular message or some messages is generated, the network defines and allocates the network function module identifier uniquely corresponding to the network function to the network function module. The network function module identifier defines the message identifier based on the message that can be processed by the network function module, and the message identifier is used to indicate that when a message corresponding to the message identifier arrives, the network function module may be invoked to process the message. Further, the network function module defines a message correspondence table for the message identifier, to be specific, configures at least one of the message type identifier, the timer timeout identifier, and the function type identifier for each message identifier, indicating that when any message that carries the at least one of the message type identifier, the timer timeout identifier, and the function type identifier arrives, the network function module may be invoked to process the message. Alternatively, the message identifier Message ID may be the message type identifier Message Type ID, or may be the timer timeout identifier Timer Trigger ID, or may be the function type identifier Function Type ID. To be specific, one NF ID may be uniquely determined by using the Message Type ID or the Timer Trigger ID or the Function ID, so as to determine the corresponding network function module.

The generation of the service rule in Table 1-2 is similar to the generation of the service rule in Table 1-1. The difference is that the message identifier is no longer defined, but the message correspondence table is directly defined, to be specific, the at least one of the message type identifier, the timer timeout identifier, and the function type identifier is configured for each message identifier, indicating that when any message that carries the at least one of the message type identifier, the timer timeout identifier, and the function type identifier arrives, the network function module may be invoked to process the message.

The generation of the service rule in Table 1-3 is similar to the generation of the service rule in Table 1-2. Details are not described herein again.

For example, the core network device may be the EIF or the PC or the two-in-one CPIMF, and an example in which the core network device is the CPIMF is used. The timer timeout identifier means that a timeout message is sent to the CPIMF when the timer inside or outside the service system expires, and the CPIMF receives the timer timeout identifier, indicating that the message indicated by the corresponding message identifier is triggered. The message type identifier or the function type identifier is from the request message, and the message type identifier is usually in a protocol header of the request message. After receiving the request message, the CPIMF parses the request message and obtains the message type identifier or the function type identifier based on the protocol header.

For example, a detach request is used as an example. When the UE initiates the detach request to the CPIMF, or a detach timer maintained in a network database expires and the CPIMF is notified, correspondingly, a detach event occurs, and a detach message identifier is triggered, so as to determine a corresponding network function module by using the detach message identifier.

303. Determine a target network function module identifier corresponding to a message identifier in the service rule set.

After the service rule set is determined, the corresponding target network function module identifier may be determined in the service rule set based on the message identifier.

Optionally, the service rule in the service rule set further includes a network slice identifier, and there is a correspondence between the network slice identifier, the message identifier, and the network function module identifier. In this case, that the core network device determines a target network function module identifier corresponding to the message identifier in the service rule set may include the following content.

Aa. The core network device determines a network slice identifier of the message based on the message.

The message carries the network slice identifier of the message.

Optionally, the message carries a UE identifier, the UE identifier may be an IMEI, an IMSI, or another identifier that may uniquely identify the UE, and the core network device determines the network slice identifier based on the UE identifier.

Ab. The core network device determines the network function module identifier in the service rule set based on the message identifier and the network slice identifier of the message.

The core network device determines a service rule group based on the network slice identifier of the message. It may be understood that the network function module applied to a network slice may add the network slice identifier to the service rule in each service rule set. To be specific, each service rule corresponds to one network slice identifier, service rules of a same network slice identifier form a service rule group, and the service rule group can provide various functions of the network slice. It may be understood that, after determining the network slice identifier, the core network device further determines the service rule group. The service rule group includes the service rules of the same network slice identifier and corresponds to one network slice. Therefore, the core network device only needs to use the network slice identifier of the message to determine the service rule group that is the same as the network slice identifier of the message, and when searching for the network function module corresponding to a matching message, the core network device only needs to search from the service rule group. This can narrow a search matching range and improve search efficiency.

Optionally, in addition to a manner of dividing the service rule set into a plurality of service rule groups, a plurality of service rule sets may be further directly set. In this case, the plurality of the service rule sets are stored in the core network device or the storage device, service rules in one service rule set have the same network slice identifier, and one service rule set corresponds to one network slice. In this manner, step Ba is the same as the foregoing step Aa.

Step Bb may specifically be that the core network device determines the service rule set based on the network slice identifier.

After the network slice identifier of the message is determined in step Ba, the service rule set corresponding to the network slice identifier of the message may be determined from the plurality of the service rule sets. The core network device determines, based on the message identifier of the message, the target network function module identifier corresponding to the message identifier in the service rule set.

It should be noted that the core network device may determine the network slice identifier in a plurality of manners based on the UE identifier. The following gives two manners.

Manner 1: A correspondence between the UE identifier and the network slice identifier is predefined by a subscription data center. Optionally, that the core network device determines the network slice identifier based on the UE identifier includes: querying and determining, by the core network device, the network slice identifier in the subscription data center based on the UE identifier, where the correspondence between the network slice identifier and the UE identifier is predefined by the subscription data center and is stored in the subscription data center.

Manner 2: The UE identifier includes UE identification information and the network slice identifier corresponding to the UE identifier. Optionally, that the core network device determines the network slice identifier based on the UE identifier includes:

determining, by the core network device, the network slice identifier by parsing the UE identifier, where the UE identifier is a UE identifier that carries the network slice identifier and that is pre-allocated by the subscription data center.

It may be understood that when the manner 1 is used, the core network device may directly query the network slice identifier corresponding to the UE identifier from the subscription data center. When the manner 2 is used, the core network device may directly parse the enhanced UE identifier to obtain the network slice identifier. Specific selection may be made according to actual conditions, and this is not limited herein.

The foregoing is a process of configuring and selecting the network slice for the request message of the UE, and the following describes the process of configuring and selecting the network slice for the message.

Optionally, the message is the message inside the service system in which the core network device is located, and that the core network device determines a target service rule in the service rule set based on the message includes the following content.

Ca. The core network device determines the service rule group from the service rule set based on the timer timeout identifier in the message.

The service rule group is configured from the service rule set by the network function module based on a service requirement of the UE, where the network function module is in the service system in which the core network device is located.

It may be understood that, for a type of UE, a fixed service rule usually belongs to the UE, and the service rule set does not distinguish which is a service rule of specific UE. Therefore, the service rule set may be divided into groups, and each group corresponds to a requirement of one type of UE.

Cb. The core network device determines the target service rule from the service rule set based on the timer timeout identifier.

It may be understood that, after the timer timeout identifier is determined, the corresponding message identifier may be determined, and further the service rule having the message identifier can be determined in the service rule group. The service rule group usually does not have two different service rules for a same event, but have a one-to-one relationship between an event and a service rule.

Optionally, the service rule in the service rule set further includes the network slice identifier, and that the core network device determines the service rule group from the service rule set based on the timer timeout identifier in the internal message includes:

determining, by the core network device, the network slice identifier based on the timer timeout identifier.

It may be understood that because the timer timeout identifier already corresponds to the message identifier in a process of defining the event, the network slice identifier may be learned by using the service rule in which the message identifier is located.

Cc. The core network device determines the service rule group based on the network slice identifier.

The service rule group includes service rules that have a same network slice identifier and that are configured from the service rule set by the subscription data center based on the service requirement of the UE.

It may be understood that after the network slice identifier is determined, the service rules having the same network slice identifier may be determined.

Optionally, that core network device determines the target service rule from the service rule group based on the timer timeout identifier includes:

determining, by the core network device, the corresponding message identifier based on the timer timeout identifier.

It may be understood that, because there is a correspondence between the timer timeout identifier and the message identifier, determining the corresponding message identifier by using the timer timeout identifier only needs query of the correspondence.

Cd. The core network device determines the target service rule from the service rule group based on the message identifier.

It may be understood that different from step 302 in which selection is made from the service rule set, the core network device makes a selection from the service rules having the same network slice identifier. Because a selection range is smaller, a selection speed is higher, resulting in a direct effect of a shorter response time.

304. Send the message to a network function module.

After determining the message identifier in the target service rule, the core network device may determine the corresponding network function module identifier, so as to send the message to the corresponding network function module.

Optionally, the network function module identifier determined by the core network device is only the identification information of the network function module, and the core network device requests the access address of the corresponding network function module from the service management framework module based on the network function module identifier. The service management framework module returns the access address of the corresponding network function module, and the core network device uses the access address to send the message to the network function module.

It can be learned that the core network device in this embodiment of the present invention first receives the message, then obtains the service rule set, and determines the target network function module identifier in the service rule set by using the message identifier carried in the message. The service rule includes the message identifier and the network function module identifier corresponding to the message identifier, and the network function corresponding to the target service rule can be found by finding the target network function module identifier. It can be learned that in this embodiment of the present invention, the service rule in the service rule set may be changed. Therefore, when a new function service is deployed in the network or an existing service is updated (in other words, when the network function is dynamically adjusted), one or more service rules corresponding to the network function in the service rule set are adjusted, and then the method embodiment in the present invention is performed to implement a subsequent message exchange process, so as to improve execution efficiency of the network. The following uses a procedure of an attach network service as an example to describe a process of configuring the attach network service and a role that this service configuration plays when the EIF selects a network slicing service for an attach request of the UE.

The process of configuring the attach network service is as follows:

First, after the attach network service corresponding to the attach request of the UE is generated, a unique network function module identifier is configured for the service, namely, an Attach NF ID, and a message identifier is defined at the same time. The identifier indicates an event that triggers the Attach NF ID. The message identifier is an Attach Message ID, and the Attach Message ID and the Attach NF ID are stored as one attach network service rule.

Next, an event correspondence table of the Attach Message ID is defined, namely, the attach request that is sent by the UE corresponding to the Attach Message

ID, and the attach request is used as a condition for triggering the Attach Message ID. Because there is no attach event triggered within the network, the Timer Trigger ID is set to N/A, to be specific, the final Attach Message ID corresponds to an Attach Message Type ID, and the Timer Trigger ID is set to N/A and the Attach Message Type ID is added to the attach network service rule.

Then, a service rule group in which the attach network service is located is determined, and a unified network slice identifier in the service rule group, namely, a Slice ID, is added to the attach network service rule. The attach network service rule finally generated is shown in the following Table 2.

TABLE 2

| Slice ID | Attach Message ID | | Attach NF ID |
|---|---|---|---|
| | Attach Message Type ID | N/A | |

Then, the configured attach network service rule is added to the core network device, for example, in a configuration file of a network slice A.

Finally, when an operator determines to deploy the network slice A, and the network slice A is instantiated, to be specific, an actual operating environment of the network slice A and required hardware and software resources are provided, a service rule group that includes all service rules stored in a policy database or stored in the network slice A is configured on the EIF, and the entire configuration process is completed.

A process in which the EIF uses the service rule set of the attach network service to select a corresponding network function for the attach request of the UE is as follows:

First, when the UE subscribes to and registers with the network, the subscription data center predefines a network slice, for example, the foregoing configured network slice A. In this case, the subscription data center has two methods for associating the UE with the network slice A. A case 1 is generating a correspondence table between the UE identifier and the network slice A for the UE. If the UE identifier is an identifier that uniquely identifies the UE, such as the IMSI or the IMEI, the correspondence table is a correspondence between a unique identifier and a Slice ID_A and is stored in the policy database. A case 2 is allocating, to the UE, an ID enhanced unique identifier that includes the Slice ID_A of the network slice A.

The following describes the case 1.

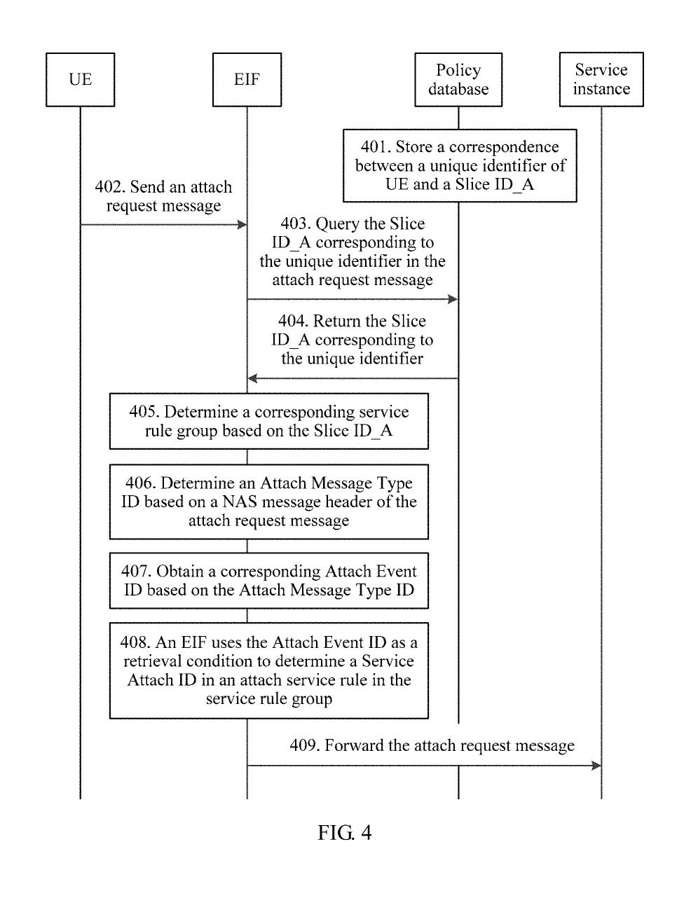

With reference to an embodiment of FIG. 3, referring to FIG. 4, FIG. 4 is a diagram of another embodiment of a message exchange method according to an embodiment of the present invention. As shown in FIG. 4, UE, an EIF, a policy database, and an attach network service instance are included, and a process of executing the attach request may include the following steps.

401. A policy database stores a correspondence between a unique identifier of UE and a Slice ID_A.

This step is a prerequisite step for an actual execution step, may actually be directly completed in a configuration process, and may not necessarily be configured in a use process. The unique identifier may be an identifier such as an IMSI or an IMEI that uniquely identifies the UE.

402. The UE sends an attach request message to an EIF.

This step is that the UE sends the attach request message to a core network device in an actual UE service processing procedure, so that the core network device identifies the request message.

403. The EIF queries, from the policy database based on the unique identifier in the attach request message, the Slice ID_A corresponding to the unique identifier.

404. The policy database returns the Slice ID_A corresponding to the unique identifier.

Step 403 and step 404 are only a case of querying a slice ID. In addition, there may be further a case in which all unique identifiers and corresponding Slice ID_A may be pre-stored in the EIF. In this case, the EIF only needs to perform local query based on the unique identifier to determine the Slice ID_A.

405. The EIF determines a corresponding service rule group based on the Slice ID_A.

406. The EIF determines an Attach Message Type ID based on a NAS message header of the attach request message.

It should be noted that step 406 is not a mandatory step, and the EIF may also parse the unique identifier from the attach request message in step 403, and directly obtain the Attach Message Type ID by parsing. The foregoing step 406 is required only when the Attach Message Type ID is included in the NAS message header.

407. The EIF obtains a corresponding Attach Message ID based on the Attach Message Type ID.

The Attach Message Type ID is obtained, and then the corresponding Attach Message ID may be determined based on a corresponding storage table.

408. The EIF uses the Attach Message ID as a retrieval condition to determine an Attach NF ID in an attach network service rule in the service rule group.

409. The EIF forwards the attach request message to an attach network service instance corresponding to the Attach NF ID.

It should be noted that step 407 and step 408 are also not mandatory steps. Steps 407 and 408 may also be directly included in step 409. When the attach request message is sent, the Attach NF ID is directly located in the service rule group based on the Attach Message Type ID.

The following describes the case 2.

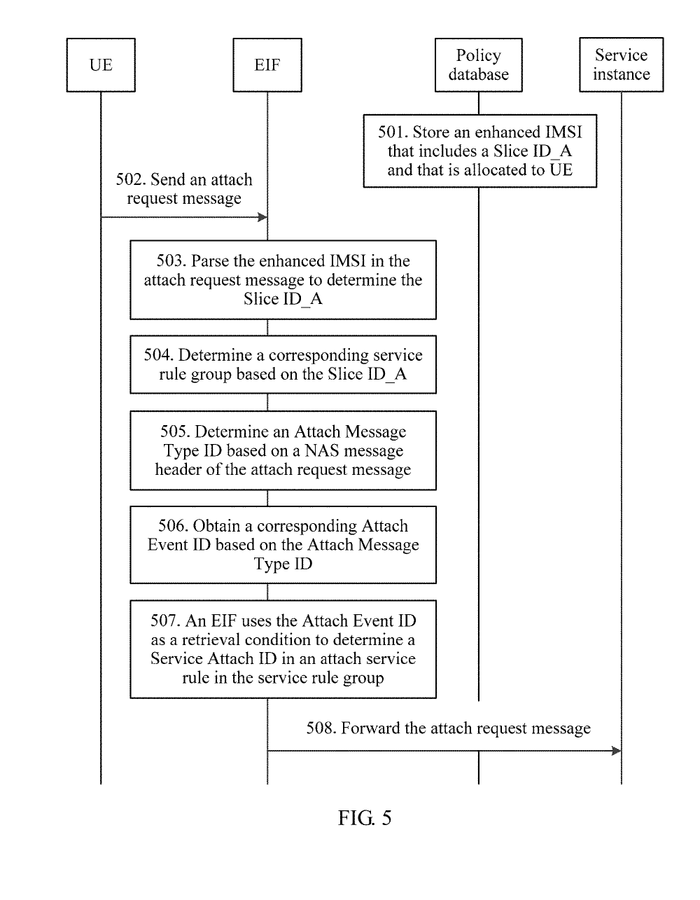

Referring to FIG. 5, FIG. 5 is a diagram of another embodiment of a message exchange method according to an embodiment of the present invention. As shown in FIG. 5, UE, an EIF, a policy database, and an attach network service instance are included, and a UE identifier is an enhanced IMSI. Step 504 to step 508 are similar to step 405 to step 409, and details are not described again. A process of executing the attach request may further include the following steps:

501. A policy database stores an enhanced IMSI that includes a Slice ID_A and that is allocated to UE.

502. The UE sends an attach request message to an EIF.

503. The EIF parses the enhanced IMSI in the attach request message to determine the Slice ID_A.

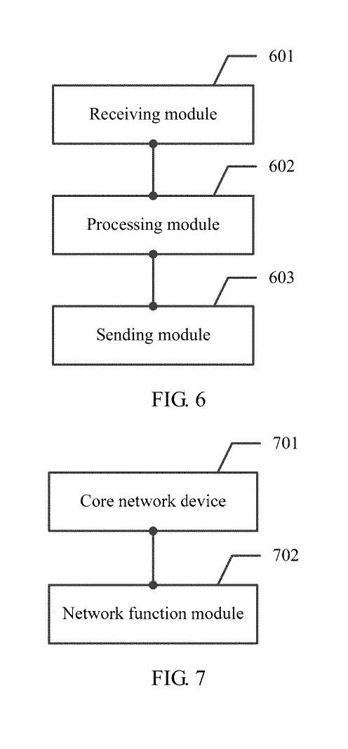

The foregoing describes a message exchange method in an embodiment of the present invention, and the following describes a core network device in an embodiment of the present invention. Referring to FIG. 6, FIG. 6 is a diagram of an embodiment of a core network device according to an embodiment of the present invention, including:

a receiving module 601, configured to receive a message, where the message carries a message identifier.

The receiving module 601 is configured to implement step 301 in an embodiment shown in FIG. 3. A related function description of the receiving module 601 is similar to the description of step 301 in the embodiment shown in FIG. 3, and details are not described herein again.

Optionally, the message is a message sent by a device inside a service system in which the core network device is located, or a message sent by a device outside the service system. Both types of messages carry the message identifier, and may also be received by the receiving module 601. In addition, optionally, the message identifier includes at least one of a timer timeout identifier, a message type identifier, and a function type identifier. In addition to being classified into internal and external messages, the message may be further classified into a request message and a trigger message based on functions of the message. The two messages may respectively carry different types of identifiers, for example, the request message may carry the message type identifier, and the trigger message may carry the timer timeout identifier. For a specific description of the two identifiers, refer to the description of step 301 in the embodiment shown in FIG. 3. Details are not described herein again.

A processing module 602 is configured to obtain a service rule set, where a service rule in the service rule set includes the message identifier and a network function module identifier corresponding to the message identifier.

The processing module 602 is configured to implement step 302 in the embodiment shown in FIG. 3. A related function description of the processing module 602 is similar to the description of step 302 in the embodiment shown in FIG. 3, and details are not described herein again.

It should be noted that there are a plurality of manners of obtaining the service rule set. Optionally, the service rule set is obtained from a storage device, or the service rule set is locally read from the core network device. The service rule set may be obtained in the two manners. In consideration of a storage form of the service rule set, the service rule set may be a configuration file. Therefore, the service rule set may be directly configured on local storage of the core network device, or may be stored in the storage device. Therefore, there are two cases of obtaining the service rule set from the storage device: one case is that the core network device does not store the service rule set; and the other case is that although the configuration file is available, the configuration file needs to be updated. In this case, the service rule set may be directly obtained from the storage device. For details, refer to the description of step 302 in the embodiment shown in FIG. 3. Details are not described herein again.

A processing module 602 is configured to determine a target network function module identifier corresponding to the message identifier in the service rule set.

The processing module 603 is configured to implement step 303 in the embodiment shown in FIG. 3. A related function description of the processing module 603 is similar to the description of step 303 in the embodiment shown in FIG. 3, and details are not described herein again.

Optionally, the processing module is specifically configured to determine the corresponding target network function module identifier in the service rule set based on the timer timeout identifier and/or the message type identifier that are/is carried in the message. It may be understood that the message may carry the timer timeout identifier or may carry the message type identifier, and certainly may further carry the timer timeout identifier and the message type identifier. Because there is a storage structure of Table 1-1, Table 1-2, or Table 1-3 in the three cases, the corresponding target network function module identifier can be successfully found. For details, refer to the similar description of step 303 in the embodiment shown in FIG. 3. Details are not described herein again.

In addition, for an application scenario of a network slice, optionally, the message further carries a UE identifier, the service rule in the service rule set further includes a network slice identifier, and the network slice identifier corresponds to the network slice. The processing module 603 is specifically configured to: determine the network slice identifier based on the UE identifier; determine a service rule group based on the network slice identifier, where the service rule group includes service rules having a same network slice identifier; and determine the target network function module identifier corresponding to the message identifier in the service rule group based on the message identifier of the message.

It can be learned that when applied to a network slicing service, the message further carries the UE identifier, the UE identifier uniquely corresponds to one network slice, to be specific, a network function required by the UE is provided by the network slice, each network slice corresponds to one network slice identifier, and the network slice identifier is included in each service rule in the service rule set. Therefore, the entire service rule set may be divided into several service rule groups, and each service rule group is responsible for serving one network slice.

Certainly, in a case of the network slice, in addition to a case in which a plurality of service rule groups are configured in one service rule set, a plurality of service rule sets may be directly configured, and each service rule set corresponds to one network slice.

Optionally, the message further carries the UE identifier, each network slice corresponds to one service rule set, the service rule set further includes the network slice identifier, and the network slice identifier corresponds to the network slice. The processing module 603 is specifically configured to: determine the network slice identifier based on the UE identifier; determine a target service rule set based on the network slice identifier; and determine the target network function module identifier corresponding to the message identifier in the target service rule set based on the message identifier of the message.

It can be learned that when applied to the network slicing service, the message further carries the UE identifier, the UE identifier uniquely corresponds to one network slice, to be specific, the network function required by the UE is provided by the network slice, each network slice corresponds to one network slice identifier, and the network slice identifier is included in each service rule in the service rule set. Therefore, the plurality of the service rule sets may be set, each service rule set is responsible for serving one network slice, and the network slice identifier is set in each service rule set.

The foregoing two cases may be used in the application scenario of the network slice. For details, refer to the description of step 303 in the embodiment shown in FIG. 3. Details are not described herein again.

In addition, there may also be two manners of determining the network slice identifier. Optionally, the processing module 603 is specifically configured to query and determine the network slice identifier in a subscription data center based on the UE identifier, where a correspondence between the network slice identifier and the UE identifier is stored in the subscription data center; or the core network device determines the network slice identifier by parsing the UE identifier, where the UE identifier carries the network slice identifier pre-allocated by the subscription data center.

It can be learned that actually, there are a plurality of manners of obtaining the network slice identifier by the core network device based on the UE identifier. For example, when the UE identifier is available, the network slice identifier may be directly obtained from the subscription data center. For another example, the UE identifier carries the network slice identifier, and the network slice identifier may be obtained by parsing the UE identifier. For details, refer to the description of step 303 in the embodiment shown in FIG. 3. Details are not described herein again.

The processing module 603 is further configured to determine the corresponding UE identifier based on the timer timeout identifier in the message, and a timer that generates the timer timeout identifier corresponds to the UE identifier.

It may be understood that, for the trigger message, the UE identifier is usually not directly included in the trigger message, but in a context database of the UE. Because maintenance of the timer corresponds to the UE, the UE may be corresponded by using the timer timeout identifier, so as to determine the UE identifier in the context database of the UE. For details, refer to the description of step 303 in the embodiment shown in FIG. 3. Details are not described herein again.

A sending module 603 is configured to send the message to a network function module corresponding to the target network function module identifier.

The receiving module 603 is configured to implement step 304 in the embodiment shown in FIG. 3. A related function description of the receiving module 603 is similar to the description of step 304 in the embodiment shown in FIG. 3, and details are not described herein again.

The foregoing describes a core network device in an embodiment of the present invention, and the following describes a network system that includes the foregoing core network device in an embodiment of the present invention. The network system may run on a server of a general-purpose architecture. Referring to FIG. 7, FIG. 7 is a diagram of an embodiment of a network system according to an embodiment of the present invention. A core network device is a process coordinator module, and the network system may include:

a core network device 701, configured to: receive a message, where the message includes a message identifier; obtain a service rule set, where a service rule in the service rule set includes the message identifier and a network function module identifier corresponding to the message identifier; determine a target network function module identifier corresponding to the message identifier in the service rule set; and send the message to a network function module 702 corresponding to the target network function module identifier.

The core network device 701 is a core network device in the embodiment shown in FIG. 6, and the core network device 701 can implement step 301 to step 304 in the embodiment shown in FIG. 3. A related function description of the core network device 703 is similar to the descriptions of step 301 to step 304 in the embodiment shown in FIG. 3, and details are not described herein again.

The network function module 702 is configured to: receive the message sent by the core network device 701, and provide a network function service.

It can be learned that the network function module 702 is mainly configured to: receive the message sent by the core network device 701, and provide the network function service corresponding to the message. The network function module 702 can customize the service rule and the service rule set, and may further store the service rule or the service rule set in the network function module 702, or certainly, may register the service rule or the service rule set in a service management framework module.

Optionally, the message identifier includes at least one of a timer timeout identifier, a message type identifier, and a function type identifier. For functions of the three identifiers and respective corresponding manners, refer to the description of step 302 in the embodiment shown in FIG. 3, and details are not described herein again.

Optionally, the message is a message sent by a device inside a service system in which the core network device 701 is located to the core network device 701, or a message sent by a device outside the service system to the core network device 701. It may be understood that there may be two sources of the message: inside the service system and outside the service system. For processing manners of the two types of messages, refer to the description of step 302 in the embodiment shown in FIG. 3. Details are not described herein again.

Optionally, the core network device 701 is specifically configured to locally read the service rule set from the core network device 701. Alternatively, the system further includes a storage device, configured to store the service rule set, and the core network device 701 is specifically configured to obtain the service rule set from the storage device.

It should be noted that there are a plurality of manners of obtaining the service rule set. Optionally, the service rule set is obtained from the storage device, or the service rule set is locally read from the core network device 701. The service rule set may be obtained in the two manners. In consideration of a storage form of the service rule set, the service rule set may be a configuration file. Therefore, the service rule set may be directly configured on local storage of the core network device 701, or may be stored in the storage device. Therefore, there are two cases of obtaining the service rule set from the storage device: one case is that the core network device 701 does not store the service rule set; and the other case is that although the configuration file is available, the configuration file needs to be updated. In this case, the service rule set may be directly obtained from the storage device. For details, refer to the description of step 302 in the embodiment shown in FIG. 3. Details are not described herein again.

In addition, in an application scenario of a network slice, optionally, the service rule in the service rule set further includes a network slice identifier, and when the network slice identifier in the service rule and the message identifier correspond to the network function module identifier, the core network device 701 is further configured to determine a network slice identifier of the message based on the message. The core network device 701 is specifically configured to determine the network function module identifier in the service rule set based on the message identifier and the network slice identifier of the message.

It can be learned that in some cases, for example, in the application scenario of the network slice, a plurality of network slices may have a same message identifier. In this case, the corresponding network function module identifier cannot be found by using the message identifier only. After the message identifier needs to be associated with the network slice identifier to determine the network slice, the corresponding network function module identifier is determined by using the message identifier in the service rule set corresponding to the network slice. For details, refer to the description of step 303 in the embodiment shown in FIG. 3. Details are not described herein again.

In addition, optionally, when the message carries a UE identifier, the network slice identifier of the message is determined based on the UE identifier, or the network slice identifier carried in the message is obtained. It may be understood that in addition to the foregoing manner, both the message identifier and the network slice identifier are associated with the network function module identifier, so as to determine the network function module identifier by using two identifiers. When the message carries the UE identifier, the network slice identifier of the message may be directly determined by using the UE identifier, and the service rule in the service rule set corresponding to the network slice identifier is determined by using the message identifier in the message, so as to determine the network function module identifier. For details, refer to the description of step 303 in the embodiment shown in FIG. 3. Details are not described herein again.

Optionally, when the message carries the UE identifier, there may be two manners of specifically determining the network slice identifier by the core network device 701 based on the UE identifier. One manner is querying and determining the network slice identifier of the message in a subscription data center based on the UE identifier, where a correspondence between the network slice identifier of the message and the UE identifier is stored in the subscription data center. The other manner is determining the network slice identifier of the message by parsing the UE identifier, where the UE identifier carries the network slice identifier. The corresponding network slice identifier may be accurately obtained by using the UE identifier in the two manners. For details, refer to the description of step 303 in the embodiment shown in FIG. 3. Details are not described herein again.

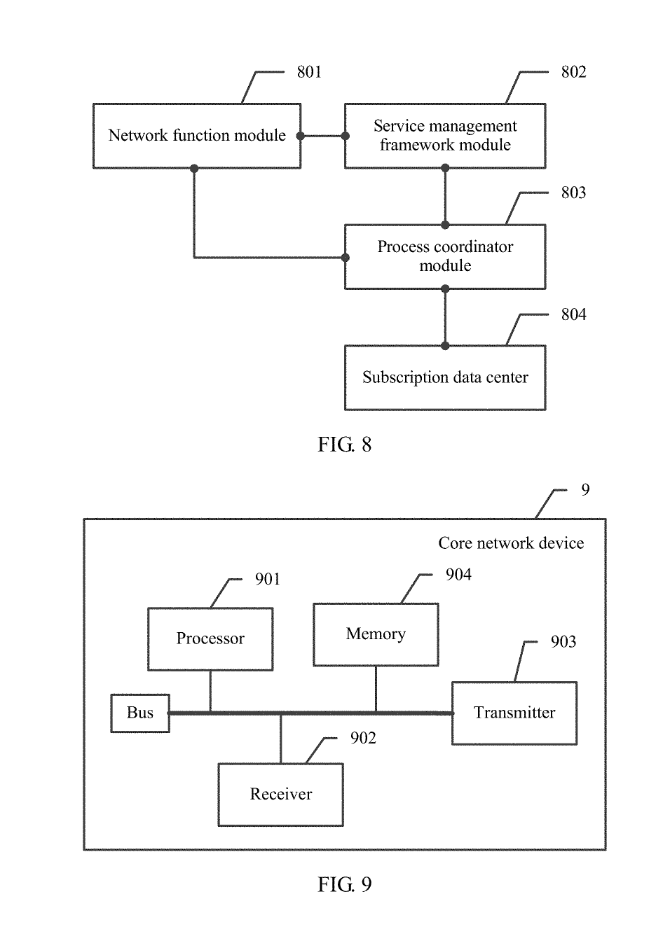

The foregoing describes a core network device in an embodiment of the present invention, and the following describes a network system that has the foregoing core network device in an embodiment of the present invention. The network system may run on a server of a general-purpose architecture. Referring to FIG. 8, FIG. 8 is a diagram of an embodiment of a network system according to an embodiment of the present invention. A core network device is a process coordinator module, and the network system may include:

a network function module 801, configured to: define a service rule and provide a network function service corresponding to the service rule, where the service rule includes a message identifier and a service identifier corresponding to the message identifier, and the service identifier corresponds to the network function service; and

a service management framework module 802, configured to register the service rule and a network function module corresponding to the service rule, and further configured to store a service rule set that includes the service rule in the network system.

It can be learned that functions of the network function module 801 and the service management framework module 802 cooperate to generate the service rule and register the service rule and the service rule set. After registration is completed, another device can find a corresponding network function service based on the service rule, so as to quickly locate the network function service and implement an effect of rapid network function selection.

A process coordinator module 803 is configured to: receive a message, where the message includes a message identifier; obtain the service rule set; determine a target network function module identifier corresponding to the message identifier in the service rule set; and send the message to a network function service corresponding to the target network function module identifier. It should be noted that the process coordinator module 803 is mainly configured to: receive the message, determine the corresponding service rule based on the message, and finally forward the message to the corresponding network function service based on the service rule. A function of the process coordinator module 803 is the same as that of the core network device in the embodiment shown in FIG. 3. For details, refer to the core network device and the description of the core network device in the embodiment shown in FIG. 3. Details are not described herein again.

Optionally, there are a plurality of manners of a specific process of locating the network function service based on the service rule. The following uses one case as an example. The process coordinator module 803 is further specifically configured to send the network function module identifier to the service management framework module 802.

The service management framework module 802 is further configured to: receive and determine, based on the network function module identifier, a network address of the network function module corresponding to the network function module identifier, and send the network address to the process coordinator module 803.

It can be learned that, the process coordinator module 803 first determines the message identifier of the received message, further queries the corresponding network function module identifier by using the service rule set, and sends the network function module identifier to the service management framework module 802. The service management framework module 802 registers all network function modules 801 and network function services. Therefore, the service management framework module 802 determines the network address of the corresponding network function module 801 based on the network function module identifier and returns the network address to the process coordinator module 803. After learning the network address, optionally, the process coordinator module 803 forwards, based on the network address, the message to the network function module 801 corresponding to the network address.

It should be noted that when the message identifier is determined, if the service rule set uses a format of Table 1-1, there are two correspondences, a message type identifier and a timer timeout identifier separately correspond to the message identifier, and the message identifier further corresponds to the network function module identifier. In an actual message receiving process, the message type identifier and/or the timer timeout identifier are/is first received, the message identifier is determined based on at least one of the two identifiers, and then the corresponding target network function module identifier is determined based on the message identifier. If the service rule set is in a form of Table 1-2 or Table 1-3, the corresponding network function module identifier is directly determined by using the message type identifier and/or the timer timeout identifier.

In addition, because the service management framework module 802 registers all service rules, the network function modules, and the corresponding network function services, the service management framework module 802 can actively update the service rule set when determining that the service rule is changed. Optionally, the service management framework module 802 is further configured to: determine that the service rule of the registered network function module is changed; and update, based on a changed service rule set, the service rule set stored in the network system.

It should be noted that in addition to updating the service rule, the service rule may be further added or deleted.

Optionally, in an application scenario of a slicing network, the network system further includes a subscription data center 804, configured to predefine and store a correspondence between the network slice identifier and a UE identifier, and the network slice identifier corresponds to a network slice.

In this case, a specific process in which the process coordinator module 803 determines the target network function module identifier is:

determining the network slice identifier based on the UE identifier, where the service rule in the service rule set further includes the network slice identifier;

determining a service rule group based on the network slice identifier, where the service rule group includes service rules having a same network slice identifier; and

determining, based on the message identifier, the target network function module identifier corresponding to the message identifier in the service rule group.

It can be learned that the subscription data center 804 is mainly configured to: provide the correspondence between the network slice identifier and the UE identifier, and determine the network slice identifier by using the correspondence when the UE identifier is available. Then, the process coordinator module 803 finds the corresponding service rule group based on the network slice identifier, and determines the service rule in the service rule group based on the message identifier, so as to find the corresponding target network function module identifier.

It should be noted that this scenario corresponds to a case in which one service rule set corresponds to a plurality of service rule groups. If there are a plurality of service rule sets, one service rule set is determined based on the network slice identifier.

It should be noted that the network system may further include a network function service component module, the network function service component module is configured to be invoked by one or more network function modules, and the network function service component module includes at least one of the following modules: a user data management module, a security module, a bearer management module, and a policy management module.

It can be learned that the network function service component module is mainly configured to be invoked by the one or more network function modules, and these components may be the at least one of the user data management module, the security module, the bearer management module, and the policy management module, so as to enhance a function of the network system.

The following describes a structure of a core network device in an embodiment of the present invention, and the core network device in this embodiment of the present invention may be a general-purpose processor structure. Referring to FIG. 9, FIG. 9 is a diagram of an embodiment of the core network device according to this embodiment of the present invention. A core network device 9 may include at least one processor 901, at least one receiver 902, at least one transmitter 903, and a memory 904 that are all connected to a bus. The memory 904 includes memory and external storage. The memory is configured to store a computer instruction that is to be executed by the processor 901 and related data. The external storage is configured to store a configuration file and another file of the core network device. The processor 901 runs the computer-executable instruction in the memory to perform step 301 to step 304 in the embodiment shown in FIG. 3. The core network device provided in this embodiment of the present invention may have more or fewer components than those shown in FIG. 9, may combine two or more components, or may have different component configurations or settings. Various components may be implemented by hardware including one or more signal processing and/or application-specific integrated circuits, by software, or by a combination of hardware and software.

Specifically, for the embodiment shown in FIG. 6, the processor 901 can implement a function of a processing module 602 in the embodiment shown in FIG. 6. The receiver 902 can implement a receiving module 601 in the embodiment shown in FIG. 6. The transmitter 903 can implement a sending module 603 in the embodiment shown in FIG. 6.

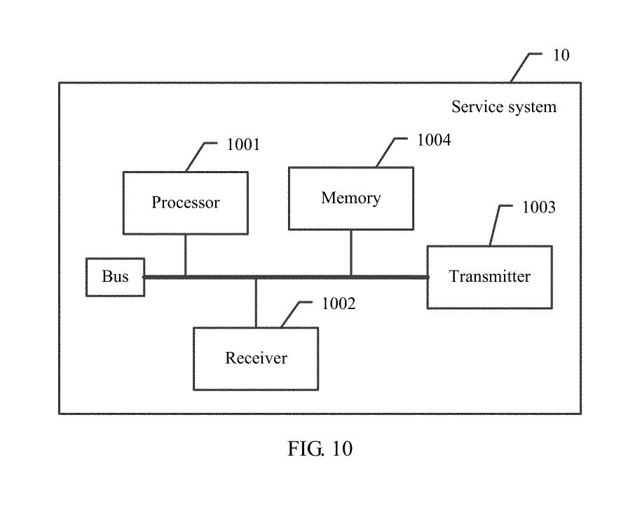

The following describes a structure of a network system in an embodiment of the present invention, and the network system in this embodiment of the present invention may be a general-purpose server architecture. Referring to FIG. 10, FIG. 10 is a diagram of an embodiment of the network system according to this embodiment of the present invention. A network system 10 may include at least one processor 1001, at least one receiver 1002, at least one transmitter 1003, and a memory 1004 that are all connected to a bus. The memory 1004 includes memory and external storage. The memory is configured to store a computer instruction that is to be executed by the processor 1001 and related data. The external storage is configured to store policy data and other data of the network system. The processor 1001 runs the computer-executable instruction in the memory. The network system provided in this embodiment of the present invention may have more or fewer components than those shown in FIG. 10, may combine two or more components, or may have different component configurations or settings. Various components may be implemented by hardware including one or more signal processing and/or application-specific integrated circuits, by software, or by a combination of hardware and software.

Specifically, for the embodiment shown in FIG. 8, the processor 1001 can implement functions of a network function module 801, a service management framework module 802, and a process coordinator module 803 in the embodiment shown in FIG. 8. The processor 1001 in combination with the memory 1004 can implement a function of a subscription data center 804 in the embodiment shown in FIG. 8. The receiver 1002 and the transmitter 1003 are configured to receive and send a message inside or outside a service system. It may be clearly understood by persons skilled in the art that, for the purpose of convenient and brief description, for a detailed working process of the foregoing system, apparatus, and unit, refer to a corresponding process in the foregoing method embodiments, and details are not described herein.

In the several embodiments provided in this application, it should be understood that the disclosed system, apparatus, and method may be implemented in other manners. For example, the described apparatus embodiment is merely an example. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected according to actual requirements to achieve the objectives of the solutions of the embodiments.

In addition, functional units in the embodiments of the present invention may be integrated into one processing unit, or each of the units may exist alone physically, or two or more units are integrated into one unit. The integrated unit may be implemented in a form of hardware, or may be implemented in a form of a software functional unit.

When the integrated unit is implemented in the form of a software functional unit and sold or used as an independent product, the integrated unit may be stored in a computer-readable storage medium. Based on such an understanding, the technical solutions of the present invention essentially, or the part contributing to the prior art, or all or some of the technical solutions may be implemented in the form of a software product. The software product is stored in a storage medium and includes several instructions for instructing a computer device (which may be a personal computer, a server, or a network device) to perform all or some of the steps of the methods described in the embodiments of the present invention. The foregoing storage medium includes: any medium that can store program code, such as a USB flash drive, a removable hard disk, a read-only memory (ROM, Read-Only Memory), a random access memory (RAM, Random Access Memory), a magnetic disk, or an optical disc.

The foregoing embodiments are merely intended for describing the technical solutions of the present invention, but not for limiting the present invention. Although the present invention is described in detail with reference to the foregoing embodiments, persons of ordinary skill in the art should understand that they may still make modifications to the technical solutions described in the foregoing embodiments or make equivalent replacements to some technical features thereof, without departing from the spirit and scope of the technical solutions of the embodiments of the present invention.

What is claimed is:

1. A message exchange method, comprising:
receiving, by a core network device, a message, wherein the message carries a message identifier;
obtaining, by the core network device, a service rule set, wherein a service rule in the service rule set comprises the message identifier and a network function module identifier corresponding to the message identifier;
determining, by the core network device, a target network function module identifier corresponding to the message identifier in the service rule set; and
sending the message to a network function module corresponding to the target network function module identifier.

2. The message exchange method according to claim 1, wherein the message is a message sent by a device inside a service system in which the core network device is located, or a message sent by a device outside the service system.

3. The message exchange method according to claim 1, wherein the message identifier comprises any one or combination of the following: a timer timeout identifier, a message type identifier, and a function type identifier.

4. The message exchange method according to claim 1, wherein the obtaining, by the core network device, a service rule set comprises: locally reading, by the core network device, the service rule set from the core network device; or
obtaining, by the core network device, the service rule set from a storage device.

5. The message exchange method according to claim 1, wherein the service rule in the service rule set further comprises a network slice identifier, the network slice identifier in the service rule and the message identifier correspond to the network function module identifier, and the method further comprises:
determining, by the core network device, a network slice identifier of the message based on the message; and
the determining, by the core network device, the target network function module identifier corresponding to the message identifier in the service rule set comprises:
determining, by the core network device, the network function module identifier in the service rule set based on the message identifier and the network slice identifier of the message.

6. The message exchange method according to claim 5, wherein the determining, by the core network device, a network slice identifier of the message based on the message comprises:
determining, by the core network device, the network slice identifier of the message based on a UE identifier when the message carries the UE identifier; or
obtaining, by the core network device, the network slice identifier carried in the message.

7. The message exchange method according to claim 6, wherein the determining, by the core network device, the network slice identifier of the message based on a UE identifier when the message carries the UE identifier comprises:
querying and determining, by the core network device, the network slice identifier of the message in a subscription data center based on the UE identifier, wherein a correspondence between the network slice identifier of the message and the UE identifier is stored in the subscription data center; or
determining, by the core network device, the network slice identifier of the message by parsing the UE identifier, wherein the UE identifier carries the network slice identifier.

8. A core network device, comprising:
a receiving module, configured to receive a message, wherein the message carries a message identifier;
a processing module, configured to: obtain a service rule set, wherein a service rule in the service rule set comprises the message identifier and a network function module identifier corresponding to the message identifier; and determine a target network function module identifier corresponding to the message identifier in the service rule set; and
a sending module, configured to send the message to a network function module corresponding to the target network function module identifier.

9. The core network device according to claim 8, wherein the message is a request message sent by a device inside a service system in which the core network device is located, or an external message sent by a device outside the service system.

10. The core network device according to claim 8, wherein the message identifier comprises at least one of a timer timeout identifier, a message type identifier, and a function type identifier.

11. The core network device according to claim 8, wherein the processing module is specifically configured to:
locally read the service rule set from the core network device; or
obtain the service rule set from a storage device.

12. The core network device according to claim 8, wherein the service rule in the service rule set further comprises a network slice identifier, the network slice identifier in the service rule and the message identifier correspond to the network function module identifier, and the processing module is further configured to determine a network slice identifier of the message based on the message; and
the processing module is specifically configured to:
determine the network function module identifier in the service rule set based on the message identifier and the network slice identifier of the message.

13. The core network device according to claim 12, wherein the processing module is specifically configured to:
determine the network slice identifier of the message based on a UE identifier when the message carries the UE identifier; or
obtain the network slice identifier carried in the message.

14. The core network device according to claim 13, wherein the processing module is further specifically configured to: when the message carries the UE identifier,
query and determine the network slice identifier of the message in a subscription data center based on the UE identifier, wherein a correspondence between the network slice identifier of the message and the UE identifier is stored in the subscription data center; or
determine the network slice identifier of the message by parsing the UE identifier, wherein the UE identifier carries the network slice identifier.

15. A network system, comprising:
a core network device, configured to: receive a message, wherein the message comprises a message identifier; obtain a service rule set, wherein a service rule in the service rule set comprises the message identifier and a network function module identifier corresponding to the message identifier; determine a target network function module identifier corresponding to the message identifier in the service rule set; and send the message to a network function module corresponding to the target network function module identifier; and
the network function module, configured to: receive the message sent by the core network device, and provide a network function service.

16. The network system according to claim 15, wherein the message identifier comprises at least one of a timer timeout identifier, a message type identifier, and a function type identifier.

17. The network system according to claim 15, wherein the message is a message sent by a device inside a service system in which the core network device is located to the core network device, or a message sent by a device outside the service system to the core network device.

18. The network system according to claim 15, wherein
the core network device is specifically configured to locally read the service rule set from the core network device; or
the system further comprises a storage device, configured to store the service rule set, and the core network device is specifically configured to obtain the service rule set from the storage device.

19. The network system according to claim 15, wherein the service rule in the service rule set further comprises a network slice identifier, the network slice identifier in the service rule and the message identifier correspond to the network function module identifier, and the core network device is further configured to determine a network slice identifier of the message based on the message; and
the core network device is specifically configured to determine the network function module identifier in the service rule set based on the message identifier and the network slice identifier of the message.

20. The network system according to claim 19, wherein the core network device is further specifically configured to:
determine the network slice identifier of the message based on a UE identifier when the message carries the UE identifier; or
obtain the network slice identifier carried in the message.
